(19) United States
(12) Patent Application Publication
(10) Pub. No.: US 2025/0205642 A1
(43) Pub. Date: Jun. 26, 2025

(54) Copper and Manganese Containing Chabazite SCR Catalyst for N2O Reduction

(71) Applicant: Umicore AG & Co. KG, Hanau-Wolfgang (DE)

(72) Inventors: Frank Welsch, Rodenbach (DE); Peter Sams HAMMERSHØI, Eppstein (DE); Frank-Walter Schuetze, Aschaffenburg (DE); Julius Koegel, Rodenbach (DE)

(21) Appl. No.: 18/847,706

(22) PCT Filed: Mar. 23, 2023
(86) PCT No.: PCT/EP2023/057506

§ 371 Date: Sep. 17, 2024

(30) Foreign Application Priority Data
Mar. 23, 2022 (EP) 22163777.0

(51) Int. Cl. B01D 53/94; B01J 29/78; B01J 35/56; B01J 37/02

(52) U.S. Cl. CPC B01D 53/9418; B01J 29/783; B01J 35/56; B01J 37/0244; B01J 37/0246; B01D 2251/2062; B01D 2255/2047; B01D 2255/20761; B01D 2255/50; B01D 2257/404; B01D 2258/01

(57) ABSTRACT

The present invention discloses a catalytically active composition comprising a crystalline aluminosilicate zeolite having the CHA framework type, wherein the zeolite has a SAR value of between 7 and 25, a copper content of between 3.0 and 4.5 wt.-%, a manganese content of 0.3 to 4.0 wt.-%, wherein copper and manganese are calculated as CuO and MnO and based on the total weight of the zeolite, and wherein the sum of the molar amounts of copper and manganese, divided by the molar amount of aluminum, is in the range of between 0.11 and 0.96. These catalyst substrate monoliths can be used in a process for the removal of nitrogen oxides from combustion exhaust gases, and they can be part of emissions treatment systems.

The present invention relates to catalytically active compositions for the selective catalytic reduction of nitrogen oxides from the exhaust gas of combustion engines which show low N₂O emissions. In particular, it deals with chabazites being loaded with copper and manganese. Methods for making these catalytically active compositions as well as uses thereof are also envisaged.

Zeolites are crystalline microporous aluminosilicate materials formed by corner-sharing TO₄ tetrahedra, wherein T stands for silicon (Si) or aluminum (Al), said tetrahedra being interconnected by oxygen atoms to form pores and cavities of uniform size and shape precisely defined by their crystal structure. Zeolites are also denoted as “molecular sieves” because the pores and cavities are of similar size as small molecules. This class of materials has important commercial applications as adsorbents, ion-exchangers and catalysts.

Zeolites are classified by the International Zeolite Association (IZA) according to the rules of the IUPAC Commission on Zeolite Nomenclature. Once the topology of a new framework is established, a three letter code is assigned. This code defines the atomic structure of the framework, from which a distinct X-ray diffraction pattern can be described.

It is also common to classify zeolites according to their pore size which is defined by the ring size of the biggest pore aperture. Zeolites with a large pore size have a maximum ring size of 12 tetrahedral atoms, zeolites with a medium pore size have a maximum pore size of 10 and zeolites with a small pore size have a maximum pore size of 8 tetrahedral atoms. Well-known small-pore zeolites belong in particular to the AEI, CHA (chabazite), ERI (erionite), LEV (levyne) and KFI framework types. Examples having a large pore size are zeolites of the faujasite framework type.

There are a large number of molecular sieve structures known today. Some known molecular sieves belong to certain families of structures with similar features. One specific family, the ABC-6 family, can be described as a stacking of two-dimensional periodic layers of non-connected planar 6-ring motifs, made up from 6 T-atoms (T=Si, Al etc.) connected by oxygen atoms. The resulting layer with hexagonal symmetry is also called the periodic building unit (PerBU). The stacking is typically described by a sequence of letters “A”, “B” and “C” that indicates the relative positions of neighboring layers. “A”, “B” and “C” refers to the well-known relative positions of neighboring layers when stacking hexagonal layers of close packed spheres.

The CHA framework belongs to the ABC-6 family and can be described by a repeating stacking sequence of AABBCC. This leads to a framework topology characterized by a three-dimensional 8-membered-ring pore systems containing double-six-rings (d6R) and cha cages.

Small-pore zeolites, in particular if cations like copper and iron are included in the zeolite pores, play an important role as catalysts in the so-called Selective Catalytic Reduction (SCR) of nitrogen oxides with ammonia to form nitrogen and water. The SCR process has been widely used to clean up exhaust gases which result from the combustion of fossil fuels, in particular from stationary power plants and from vehicles powered by diesel engines.

The catalytic reduction of NOₓ with NH₃ can be represented by different reaction equations. Nitric oxide (NO) is the main NOₓ compound produced in an engine. The reduction of NO is referred to as the “standard” NH₃-SCR reaction:

4NO+4NH₃+O₂→4N₂+6H₂O (1)

NO₂ is more reactive than NO. In presence of mixtures of NO and NO₂, the NH₃-SCR reaction is easier, and the so-called “fast” NH₃-SCR reaction can occur:

2NH₃+NO+NO₂→2N₂+3H₂O (2)

To take profit of the fast NH₃-SCR reaction, an additional catalyst is beneficial to oxidize part of the NO into NO₂.

Also, side reactions may occur and result in unwanted products or the unproductive consumption of ammonia:

4NH₃+3O₂→N₂+6H₂O (3)

2NH₃+2O₂→N₂O+3H₂O (4)

4NH₃+5O₂→4NO+6H₂O (5)

4NH₃+7O₂→4NO₂+6H₂O (6)

2NH₃+2NO₂+H₂O→NH₄NO₂+NH₄NO₃ (7)

In official driving cycles, exhaust gas temperatures of latest generation engines and hybrid vehicles with reduced fuel consumption and low CO₂ emission are significantly lower compared to previous engine generations. Therefore, it is necessary to obtain a NH₃-SCR catalyst which shows a high low-temperature NOₓ conversion. In general, Cu-containing zeolites display a better low-temperature NOₓ conversion than their Fe-containing counterparts. Furthermore, NH₃-SCR catalyst should release as little N₂O as possible. During conversion of NOx with a copper-promoted SCR catalyst in the exhaust gas system of diesel engines in on-road and off-road applications, the greenhouse gas N₂O is formed as a side product. This is more pronounced under elevate NO₂ contents in the exhaust gas feed.

Next to selectivity and activity, the hydrothermal stability of SCR catalysts is another essential parameter, as an NH₃-SCR catalyst has to withstand harsh temperature conditions under full load of the engine and the exposure to water vapor at temperatures up to 700° C. is known to be critical for many zeolite types.

WO 2021/219628 A1 discloses an SCR catalyst comprising a substrate, which can be a flow-through substrate or a wall-flow filter, and a coating dispersed on the substrate. The coating comprises a first non-zeolitic material comprising aluminum, an 8-membered ring pore zeolitic material selected from CHA, AEI, RTH, LEV, DDR, KFI, ERI, AFX and LTA comprising one or more of copper and iron, and a second non-zeolitic oxidic material comprising cerium and one or more of zirconium, aluminum, silicon, lanthanum, niobium, iron, manganese, titanium, tungsten, copper, molybdenum, neodymium, cobalt, chromium, tin and praseodymium; wherein at least 65 weight-% of the coating consist of the 8-membered ring pore zeolitic material comprising one or more of copper and iron. Most preferably, the zeolitic material is CHA. It was shown that coatings comprising cerium and zirconium oxide had a lower back pressure and a better NOₓ conversion than other coatings tested. The N₂O selectivity was not tested.

WO 2018/081682 A1 provides a catalyst composition comprising a zeolite having an LTA structure with iron, manganese or a combination thereof as an extra-framework metal. The zeolite has a SAR value of 15 to 70 and can contain 0.5 to 10 wt.-% of iron, manganese, or a combination thereof. Optionally, the catalyst composition can be used together with a second catalyst composition comprising a second molecular sieve selected from AEI, AFX, CHA or LTA which comprises extra-framework metals selected from antimony, bismuth, cesium, chromium, cobalt, copper, iron, manganese, molybdenum, nickel, niobium, tin, titanium, tungsten, vanadium, zinc, zirconium, and combinations thereof. It was shown that fresh and aged Mn-LTA showed a better NOₓ conversion and a lower peak concentration of N₂O than fresh and aged Mn-CHA and Mn-AFX. However, Mn-BEA, a large-pore zeolite, provided a better NOₓ conversion from about 150 to about 200° C. than all three Mn-containing small-pore zeolites.

CN 111 375 445 A discloses a method for making a molecular sieve denitration catalyst loaded with manganese. The molecular sieve supported manganese-based denitration catalyst is prepared by mixing a molecular sieve, a soluble aqueous solution of a manganese salt and a ligand to form a mixed solution, wherein the molecular sieve has opposite electrical properties with a complex formed by the manganese salt and the ligand; and performing electrostatic adsorption and other steps on the mixed solution. The molecular sieve loaded manganese-based denitration catalyst is uniform in active component particle size and distribution on the surface of the carrier, and is particularly suitable for removing nitric oxide. The molecular sieve can be selected from a long list of molecular sieves, wherein AEI, CHA, FAU and ZSM are preferred. In embodiments, a Mn-supported CHA was synthesized and subjected to sulfur aging. The sulfur-aged Mn-CHA showed a lower light-off temperature for the NH3-SCR reaction and a better NOx conversion than Mn-CHA obtained by conventional liquid ion exchange methods. The molecular sieves according to CN 111 375 445 A do not comprise any other transition metal than manganese, and the N₂O formation was not investigated.

In H Xue, X Guo, T Meng, Q Guo, D Mao and S Wang: “Cu-ZSM-5 Catalyst Impregnated with Mn—Co Oxide for the Selected Catalytic Reduction of NO: Physicochemical Property—Catalytic Activity Relationship and In Situ DRIFTS Study for the Reaction Mechanism”, ACS Catal 2021, 11, 7702-7718, it was shown that impregnating Cu-ZSM-5 with copper and manganese boosted the NH₃-SCR catalytic activity at temperatures below 200° C. The Cu-ZSM-5 zeolites used had a Cu/Al ratio of 38, corresponding to a SAR value of 76, and a copper content of 1.98 wt.-%. The zeolites were impregnated with manganese and cobalt, and the mass ratios of Mn and Co in the thus impregnated zeolites varied from 1:0.5 to 1:5. The total amount of (Mn+Co) remained constant with 10 wt.-% of the Cu-ZSM-5.

In C Song, L Zhang, Z Li, Y Lu and K Li: “Co-Exchange of Mn: A Simple Method to Improve Both the Hydrothermal Stability and Activity of Cu-SSZ-13 NH₃-SCR Catalysts”, Catalysts 2019, 9, 455-469, a series of Cu—Mn-SSZ-13 were obtained by co-exchange of Mn and Cu into SSZ-13 and compared with Cu-SSZ-13 catalysts in the selective catalytic reduction (SCR) of nitric oxide (NO) by ammonia. The aim was to improve the catalyst's low temperature activity and its resistance to hydrothermal aging simultaneously. The higher the copper content of SSZ-13, which has the CHA framework structure, the higher the low-temperature activity, but the lower the hydrothermal stability. Zeolite SSZ-13 having a SAR value were ion-exchanged with copper and optionally manganese. The zeolites obtained has Mn/Cu molar ratios of 0/10 (only Cu) to 6/10. The ion exchange degrees for the zeolites thus obtained were calculated as mol Cu (or Mn)×2/mol Al×100% based on inductively coupled plasma atomic emission spectroscopy results (ICP-AES). The ion exchange degrees of Cu ranged from 0.35 (Mn/Cu ratio=0/10) to 0.13 (Mn/Cu ratio=6/10), and the ion exchange degrees for Mn ranged from 0 (Mn/Cu ratio=0/10) to 0.17 (Mn/Cu ratio=6/10). This corresponds to Cu/Al ratios of from 0.175 (Mn/Cu ratio=0/10) to 0.065 (Mn/Cu ratio=6/10) and to Mn/Al ratios of from 0 (Mn/Cu ratio=0/10) to 0.085 (Mn/Cu ratio=6/10). Consequently, the (Cu+Mn)/Al ratios ranged from 0.15 to 0.175. The NO conversion, NO oxidation, NH₃ oxidation and NH₃ desorption of these catalysts were investigated. The catalyst called Cu(0.2)Mn(0.1) showed the highest reactivity in the low-temperature range and the best resistance to hydrothermal aging. This catalyst had a Mn/Cu ratio of 6/19, a ion exchange degree of Cu of 0.2, an ion exchange degree of Mn of 0.1, a Cu/Al molar ratio of 0.1, a Mn/Al molar ratio of 0.05 and a (Cu+Mn)/Al molar ratio of 0.15. The N₂O formation of the catalysts was not investigated.

In J Du, J Wang, X Shi, Y Shan, Y Zhang and H He: “Promoting Effect of Mn on In Situ Synthesized Cu-SSZ-13 for NH₃-SCR”, Catalysts 2020, 10, 1375-1388, the effect of Mn impregnation on the NH₃-SCR activity of in situ synthesized Cu-SSZ-13 was investigated. All Cu-SSZ-13 catalysts had a copper content of 4.6 wt.-% and a Si/Al ratio of 4.8, corresponding to a SAR value of 9.6. The Cu-SSZ-13 catalysts were impregnated with 0, 3, 5, 7, 10 and 14% Mn. The NH₃-SCR catalytic activity, the N₂ selectivity and the N₂O formation of all catalysts were investigated. Among all the catalysts, 5% Mn/Cu-SSZ-13 showed the best catalytic activity in the low temperature range, and nearly 95% NOₓ conversion was obtained around 140° C. With a further increase in the Mn content, however, the low-temperature NOₓ conversion began to decrease when compared with 5% Mn/Cu-SSZ-13. More N₂O was produced with an increase of the Mn content, indicating that the addition of Mn would decrease the N₂ selectivity of the catalysts. Nevertheless, the N₂O formation was under 20 ppm for Mn/Cu-SSZ-13 with an Mn content below 7%. 5% Mn/Cu-SSZ-13 performed the best among all the prepared catalysts.

WO 2020/047356 A1 discloses a catalyst composition for treating an exhaust gas comprising a molecular sieve which comprises exchanged copper and exchanged manganese. In preferred embodiments, the molecular sieve is selected from AEI, CHA, BEA and MF. The SAR value is between 5 and 200, most preferred between 10 and 30. The copper to manganese atomic ratio is between 0.1 to 50, preferably between 0.3 and 3.

Copper is present in an amount of 0.1 to 7 wt.-%, most preferred between 1 and 4 wt. %, and manganese is present in an amount of 0.05 to 7 wt.-%, most preferred between 0.5 and 2.5 wt.-%. In Experiments, the influence of the copper and manganese amount on the fast, slow and standard SCR and the N₂O selectivity of fresh and aged AEI zeolites was tested. The N₂O selectivity was defined as the moles N₂O formed divided by the moles of NOₓ (NOₓ defined as NO and NO₂) converted. This means that the lower the N₂O selectivity, the fewer N₂O is formed relatively to the amount of converted NOₓ. Either the copper amount was kept constant, and the manganese content was varied, or vice versa. AEI zeolites comprising copper and manganese showed an enhanced light-off temperature, a lower N₂O selectivity and a NOₓ conversion which was equal to or better than that of AEI zeolites comprising copper only. Keeping the Cu amount constant and concomitantly increasing the Mn amount, and thus lowering the Cu/Mn ratio, particularly improved the NOₓ conversion as regards the light-off temperature without a significant increase of the N₂O selectivity, which means that there was a proportional increase of the NOₓ conversion and the N₂O production. The SAR value of the AEI zeolites was not given. AEI comprising 1.5 wt.-% Cu and 1.5 wt.-% Mn performed better than CHA comprising the same amounts of Cu and Mn. In the experiments comparing AEI and CHA, the SAR values were not given, either. Experiments with two chabazites with SAR values of 13 and 22, respectively, both having Cu and Mn amounts of 1.5 wt.-% each revealed that the CHA with the lower SAR value showed a better NOₓ conversion and a lower N₂O selectivity. BEA and MFI containing either 3 wt.-% or 1.5 wt.-% of Cu and Mn each revealed that in the case of BEA, the NOₓ conversion was not influenced by the presence of Mn, whereas BEA containing Cu and Mn showed a lower N₂O formation than BEA containing Cu only; and in the case of MFI, the zeolite comprising Cu only showed both a better NOₓ conversion and a lower N₂O formation than MFI comprising both Cu and Mn.

US 2015/078989 A1 discloses a catalyst composition useful for the selective catalytic reduction of NOₓ in learn burn exhaust gas. The catalyst composition comprises an aluminosilicate material comprising silica and alumina in a CHA framework and having a silica-to-alumina ratio (SAR) of about 10 to about 25, and about 1 to about 5 weight percent of a base metal (“BM”), based on the total weight of the zeolite material, wherein said base material is disposed in said zeolite material as free and/or extra-framework exchanged material, and an alkali or alkaline earth metal (collectively “AM”) disposed in said zeolite material as free and/or extra-framework exchanged metal. The base metal is selected from chromium, manganese, iron, cobalt, nickel, copper and mixtures thereof. The alkali or alkaline earth metal is selected from sodium, potassium, rubidium, cesium, magnesium, calcium, strontium and barium. BM and AM are present, respectively, in a molar ratio of about 15:1 to about 1:1. The examples show SSZ-13 zeolites having a SAR value of 17 and being promoted with copper and a second metal which is one of calcium, potassium, magnesium, sodium, cesium or manganese.

There is a constant need for SCR catalytically active compositions which show a good NOₓ conversion, have a light-off temperature which is as low as possible, and which, at the same time, show a low N₂O selectivity.

### Problem to be Solved by the Invention

It is thus an object of the present invention to provide catalytically active compositions for the removal of nitrogen oxides from the exhaust gas of combustion engines which show a high conversion rate of nitrogen oxides to nitrogen via a good activity as well as a good selectivity for this conversion and, at the same time, a low N₂O selectivity. Another object of the present invention is to provide devices and systems for the treatment of exhaust gases of combustion engines which comprise the catalytically active compositions according to the present invention. Yet another object of the present invention is to provide a method for the abatement of NOₓ emissions, and optionally also particulate matter, from exhaust gases of internal combustion engines.

### Solution to the Problem

The object of the present invention to provide catalytically active compositions for the removal of nitrogen oxides from the exhaust gas of combustion engines which show a high conversion rate of nitrogen oxides to nitrogen via a good activity as well as a good selectivity for this conversion and, at the same time, a low N₂O selectivity is solved by a catalytically active composition comprising a crystalline aluminosilicate zeolite having the CHA framework type, wherein the zeolite has a SAR value of between 7 and 25, a copper content of between 3.0 and 4.5 wt.-%, a manganese content of 0.3 to 4.0 wt.-%, wherein copper and manganese are calculated as CuO and MnO and based on the total weight of the zeolite, and wherein the sum of the molar amounts of copper and manganese, divided by the molar amount of aluminum, is in the range of between 0.11 and 0.96.

The catalytically active compositions for the removal of nitrogen oxides from the exhaust gas of combustion engines which show a high conversion rate of nitrogen oxides to nitrogen via a good activity as well as a good selectivity for this conversion and, at the same time, a low N₂O selectivity and the devices and systems for the treatment of exhaust gases of combustion engines which comprise the catalytically active compositions are explained below, with the invention encompassing all the embodiments indicated below, both individually and in combination with one another.

The selective catalytic reduction of nitrogen oxides to nitrogen is hereinafter referred to as “SCR” or “SCR reaction”.

A “catalytically active composition” is a substance or a mixture of substances which is capable to convert one or more components of an exhaust gas into one or more other components. An example of such a catalytically active composition is, for instance, an oxidation catalyst composition which is capable of converting volatile organic compounds and carbon monoxide to carbon dioxide or ammonia to nitrogen oxides. Another example of such a catalyst is, for example, a selective catalytic reduction catalyst (SCR) composition which is capable of converting nitrogen oxides to nitrogen and water. In the context of the present invention, an SCR catalyst is a catalyst comprising a carrier substrate and a washcoat comprising an SCR catalytically active composition. An ammonia slip catalyst (ASC) is a catalyst comprising a carrier substrate, a washcoat comprising an oxidation catalyst, and a washcoat comprising an SCR catalytically active composition.

A molecular sieve is a material with pores, i.e. with very small holes, of uniform size.

These pore diameters are similar in size to small molecules, and thus large molecules cannot enter or be adsorbed, while smaller molecules can. In the context of the present invention, a molecular sieve is zeolitic. Zeolites are made of corner-sharing tetrahedral SiO₄ and AlO₄ units. They are also called “silicoaluminates” or “aluminosilicates”. In the context of the present invention, these two terms are used synonymously.

As used herein, the terminology “non-zeolitic molecular sieve” refers to corner-sharing tetrahedral frameworks wherein at least a portion of the tetrahedral sites are occupied by an element other than silicon or aluminum. If a portion, but not all silicon atoms are replaced by phosphorous atoms, it deals with so-called “silico aluminophosphates” or “SAPOs”. If all silicon atoms are replaced by phosphorous, it deals with aluminophosphates or “AlPOs”.

A “zeolite framework type”, also referred to as “framework type”, represents the corner-sharing network of tetrahedrally coordinated atoms. It is common to classify zeolites according to their pore size which is defined by the ring size of the biggest pore aperture. Zeolites with a large pore size have a maximum ring size of 12 tetrahedral atoms, zeolites with a medium pore size have a maximum pore size of 10 and zeolites with a small pore size have a maximum pore size of 8 tetrahedral atoms. Well-known small-pore zeolites belong in particular to the AEI, CHA (chabazite), ERI (erionite), LEV (levyne), AFX and KFI framework. Examples having a large pore size are zeolites of the faujasite (FAU) framework type and zeolite Beta (BEA).

A “zeotype” comprises any of a family of materials based on the structure of a specific zeolite. Thus, a specific “zeotype” comprises, for instance, silicoaluminates, SAPOs and AlPOs that are based on the structure of a specific zeolite framework type. Thus, for example, chabazite (CHA), the silicoaluminates SSZ-13, Linde R and ZK-14, the silicoaluminophosphate SAPO-34 and the aluminophosphate MeAlPO-47 all belong to the chabazite framework type. The skilled person knows which silicoaluminates, silico aluminophosphates and aluminophosphates belong to the same zeotype. Furthermore, zeolitic and non-zeolitic molecular sieves belonging to the same zeotype are listed in the database of the International Zeolite Association (IZA). The skilled person can use this knowledge and the IZA database without departing from the scope of the claims.

The silica to alumina ratio (SiO₂:Al₂O₃) of the zeolites is hereinafter referred to as the “SAR value”.

A “catalyst carrier substrate”, also just called a “carrier substrate” is a support to which the catalytically active composition is affixed and shapes the final catalyst. The carrier substrate is thus a carrier for the catalytically active composition.

A “washcoat” as used in the present invention is an aqueous suspension of a catalytically active composition and optionally at least one binder. Materials which are suitable binders are, for example, aluminum oxide, titanium dioxide, silicon dioxide, zirconium dioxide, or mixtures thereof, for example mixtures of silica and alumina.

A washcoat which has been affixed to a catalyst carrier substrate is called a “coating”. It is also possible to affix two or more washcoats to the carrier substrate. The skilled person knows that affixing two or more washcoats onto one single carrier substrate is possible by “layering” or by “zoning”, and it is also possible to combine layering and zoning. In case of layering, the washcoats are affixed successively onto the carrier substrate, one after the other. The washcoat that is affixed first and thus in direct contact with the carrier substrate represents the “bottom layer”, and the washcoat that is affixed last it the “top layer”. In case of zoning, a first washcoat is affixed onto the carrier substrate from a first face side A of the carrier substrate towards the other face side B, but not over the entire length of the carrier substrate, but only to an endpoint which is between face sides A and B. Afterwards, a second washcoat is affixed onto the carrier, starting from face side B until an endpoint between face sides B and A. The endpoints of the first and the second washcoat need not be identical: if they are identical, then both washcoat zones are adjacent to one another. If, however, the endpoints of the two washcoat zones, which are both located between face sides A and B of the carrier substrate, are not identical, there can be a gap between the first and the second washcoat zone, or they can overlap. As mentioned above, layering and zoning can also be combined, if, for instance, one washcoat is applied over the entire length of the carrier substrate, and the other washcoat is only applied from one face side to an endpoint between both face sides.

In the context of the present invention, the “washcoat loading” is the mass of the catalytically active composition per volume of the carrier substrate.

The skilled person knows that washcoats are prepared in the form of suspensions and dispersions.

Suspensions and dispersions are heterogeneous mixtures comprising solid particles and a solvent. The solid particles do not dissolve, but get suspended throughout the bulk of the solvent, left floating around freely in the medium. If the solid particles have an average particle diameter of less than or equal to 1 μm, the mixture is called a dispersion; if the average particle diameter is larger than 1 μm, the mixture is called a suspension. Washcoats in the sense of the present invention comprise a solvent, usually water, and suspended or dispersed particles represented by particles of one or more of the catalytically active compositions, and optionally particles of at least one binder as described above. This mixture is often referred to as the “washcoat slurry”. The slurry is applied to the carrier substrate and subsequently dried to form the coating as described above. In the context of the present invention, the term “washcoat suspension” is used for mixtures of solvents, particles of one or more catalytically active compositions, and optionally particles of at least one binder, irrespective of the individual or average particle sizes. This means that in “washcoat suspensions” according to the present invention, the size of individual particles as well as the average particle size of the one or more catalytically active solid particles can be less than 1 μm, equal to 1 μm and/or larger than 1 μm.

The term “mixture” as used in the context of the present invention is a material made up of two of more different substances which are physically combined and in which each ingredient retains its own chemical properties and makeup. Despite the fact that there are no chemical changes to its constituents, the physical properties of a mixture, such as its melting point, may differ from those of the components.

A “catalysed substrate monolith” is a carrier substrate comprising a catalytically active composition. The carrier may be coated with a washcoat comprising the catalytically active composition, wherein the washcoat comprises a catalytically active composition and optionally at least one binder. Alternatively, the catalytically active composition can be a component of the carrier substrate itself.

A “device” as used in the context of the present invention is a piece of equipment designed to serve a special purpose or perform a special function. The catalytic devices according to the present invention serve the purpose and have the function to remove nitrogen oxides from the exhaust gas of combustion engines. A “device” as used in the present invention may consist of one or more catalysts, also called “catalytic articles” or “bricks” as defined above.

“Upstream” and “downstream” are terms relative to the normal flow direction of the exhaust gas in the exhaust pipeline. A “zone or catalyst 1 which is located upstream of a zone or catalyst 2” means that the zone or catalyst 1 is positioned closer to the source of the exhaust gas, i.e. closer to the motor, than the zone or catalyst 2. The flow direction is from the source of the exhaust gas to the exhaust pipe. Accordingly, in this flow direction the exhaust gas enters each zone or catalyst at its inlet end, and it leaves each zone or catalyst at its outlet end.

The term “nitrogen oxides”, as used in the context of the present invention, encompasses nitrogen monoxide (NO), nitrogen dioxide (NO₂), and nitrous oxide (N₂O). By contrast, the term “NOₓ”, however, only encompasses NO and NO₂, but not N₂O, although nitrous oxide is also an oxide of nitrogen. This distinction between “nitrogen oxides” and “NOₓ” is, however, widely used by skilled persons.

The term “NOx conversion”, as used in the context of the present invention, means the percent conversion of NOₓ as defined above into nitrogen.

The “N₂O selectivity” (S_{N2O}) is the percent conversion of NOₓ and NH₃ in the gas feed into N₂O.

The N₂O selectivity can be calculated according to the equation

$${S}_{{N}_{2} O} = 2 * \frac{( {N}_{2} {O}_{out} - {N}_{2} {O}_{in} )}{( {NH}_{3 , in} - {NH}_{3 , out} + {NO}_{x , in} - {NO}_{x , out} )}$$

### Wherein

N₂Oᵢₙ=amount of N₂O at the inlet end of a catalytic device
N₂Oₒᵤₜ=amount of N₂O at the outlet end of a catalytic device
NH_{3,in}=amount of NH₃ at the inlet end of a catalytic device
NH_{3,out}=amount of NH₃ at the outlet end of a catalytic device
NO_{x,in}=amount of NOₓ at the inlet end of a catalytic device
NO_{x,out}=amount of NOₓ at the outlet end of a catalytic device

The “catalytic activity” or just “activity” is the increase in rate of a chemical reaction caused by the presence of a catalytically active composition.

The skilled person knows that the SCR reaction requires a reductant to reduce nitrogen oxides to nitrogen and water. A suitable reductant is ammonia, and the SCR reaction in presence of ammonia is known as “NH₃-SCR”. The ammonia used as reducing agent may be made available by feeding liquid or gaseous ammonia or an ammonia precursor compound into the exhaust gas. If an ammonia precursor is used, it is thermolyzed and hydrolyzed to form ammonia. Examples of such ammonia precursors are ammonium carbamate, ammonium formate and preferably urea. Alternatively, the ammonia may be formed by catalytic reactions of the ammonia precursor within the exhaust gas.

In embodiments of the present invention, the crystalline aluminosilicate zeolite having the CHA framework structure is selected from the zeotypes SSZ-13, LZ-218, Linde D, Linde R, Phi and ZK-14, with SSZ-13 being preferred.

The crystalline aluminosilicate having the CHA framework structure has a SAR value of between 7 and 25, preferably between 9 to 23, more preferably between 11 and 20, even more preferably 11 to 17 and most preferably 13 to 17.

The crystalline aluminosilicate having the CHA framework structure has a copper content of between 3.0 and 4.5 wt.-%, preferably between 3.2 to 4.5 wt.-%, more preferably 3.5 to 4.3 wt.-% calculated as CuO and based on the total weight of the zeolite.

The crystalline aluminosilicate having the CHA framework structure has a manganese content of between 0.3 to 4.0 wt.-%, preferably 0.3 to 3.5 wt.-%, more preferably 0.5 to 3.2 wt.-%, calculated as MnO and based on the total weight of the zeolite.

The “total weight of the zeolite” is the sum of the weights of the white zeolite and the weights of copper and manganese, wherein the weights of copper and manganese are calculated as the respective oxides CuO and MnO. In the context of the present invention, a “white zeolite” is an aluminosilicate zeolite consisting of TO₄ tetrahedra and having the CHA framework structure which comprises neither copper nor manganese, nor any other transition metal. Such a zeolite is colourless, also referred to as “white”, due to the absence of transition metals, which provide zeolites with a colour, for example blue in the case of a copper loading, or mixed colours in case of more than one transition metal, such as copper, is present. The skilled person knows that “white zeolites” usually comprise protons and alkali metal cations, albeit often in trace amounts. However, protons and alkali metals do not provide the zeolite with a colour. The term “white zeolite” therefore also includes aluminosilicate zeolites having the CHA framework structure which comprise protons and alkali metal cations.

The sum of the molar amounts of copper and manganese, divided by the amount of aluminum, (Cu+Mn)/Al, is in the range of between 0.11 and 0.96, preferably between 0.20 to 0.80, more preferably between 0.28 and 0.35, even more preferably 0.31 to 0.35.

The amounts of copper, manganese, aluminum, silicon, and, if applicable, of sodium, potassium, rubidium, cesium, magnesium, calcium, strontium and barium can be measured by ICP-AES (inductively coupled plasma atomic emission spectroscopy), ICP-OES (inductively coupled plasma optical emission spectroscopy) or XRF (X-ray fluorescence spectroscopy). Energy-dispersive X-ray spectroscopy, known as EDS, EDX, or EDXS allows to analyze elements having an atomic number of 8 or larger, thus enable the measurement of the above-mentioned mentioned and oxygen alike. The skilled person knows how to perform such analyses and can apply this knowledge to the zeolites according to the present invention without departing from the scope of the claims.

SAR values of zeolites can be determined by NMR (nuclear magnetic resonance), XRF or ICP-OES. Metal to metal molar ratios, for example copper to aluminum molar ratios or copper to manganese molar ratios in zeolites can be measured by ICP-OES or XRF. These methods are known to the skilled person and can be applied in the context of the present invention without departing from the scope of the claims.

Aluminosilicate chabazites and zeotypes thereof are commercially available. Methods for making chabazites are, for example, discloses in EP 2 931 406 B1, US 2018/079650 A1, WO 2017/080722 A1, US 2018/127282 A1 and WO 2018/189177 A1. In general, the synthesis of aluminosilicate zeolites comprises mixing a source of silicon, a source of aluminum, an alkali or alkaline earth metal hydroxide, water and at least one organic structure-directing agent (OSDA), and optionally a salt, for example a copper or iron salt. The mixture forms a gel, which is aged, heat-treated, purified and optionally calcined. The skilled person knows how to synthesize aluminosilicate chabazites and zeotypes thereof. It is also known that some methods for making aluminosilicate zeolites, in particular CHA, make use of OSDAs which are complexes of copper and an organic polyamine, for example copper tetraethylene pentaamine (Cu-TEPA). If such a complex of copper and an organic polyamine is used, the zeolite obtained thereof already comprises copper. In such cases, the zeolite obtained by the synthesis already contains copper. In other cases, however, the synthesis gel does not comprise copper.

In the context of the present invention, the amounts of copper and manganese can be adjusted according to the required amounts of copper and manganese and according to the required sum of the molar amounts of copper and manganese, divided by the molar amount of aluminum as indicated above by ion exchange methods. “Adjusted” means that Cu and Mn can be introduced for the first time if they are not present in the zeolite as synthesized, or their amounts can be increased or decreased if they have been introduced during the synthesis, but their amount is outside the ranges as required for the crystalline aluminosilicates according to the present invention. Increasing or decreasing the amount of the metals is particularly relevant for copper and manganese if they have been introduced by the synthesis method.

Copper, for instance, can be introduced via ion exchange. In a first step, an ammonium exchange is performed in order to remove alkali or alkaline earth metal cations from the zeolite framework by replacing them with NH₄⁺ cations. In a second step, NH₄⁺ is replaced by copper cations. The copper content of the resulting copper-containing zeolite can be easily controlled via the amount of copper salt and the number of ion exchange procedures performed. The copper content can be measured by ICP-AES or XRF as mentioned above.

Copper and manganese can also be removed by liquid ion exchange with NH₄⁺ cations.

Methods for introducing ammonium, copper and manganese cations and for removing copper and manganese cations, respectively, are well known to the skilled artisan. They can be applied to the zeolites according to the present invention without departing from the scope of the claims. For example, ammonium cations can be easily introduced via liquid ion exchange, and copper cations can also easily be introduced via liquid ion exchange, incipient wetness impregnation or solid state ion exchange.

Said methods are presented exemplarily hereinafter for the introduction of copper cations. These methods are applicable to obtain zeolites according to the present invention which are loaded with copper and manganese.

### Liquid Ion Exchange

An NH₄⁺ liquid ion exchange can be performed by treating the zeolite with an aqueous solution of an ammonium salt, for example NH₄Cl or NH₄NO₃.

A Cu²⁺ liquid ion exchange can be performed by treating the zeolite with an aqueous solution of a copper salt, for example copper acetate (Cu(Ac)₂), copper nitrate (Cu(NO₃)₂), copper acetylacetonate (Cu(acac)₂) or copper chloride (CuCl₂). This procedure can be repeated multiple times in order to achieve the desired copper content.

It is obvious for the skilled person that the copper to zeolite ratio in liquid ion exchange can be adjusted according to the desired copper content of the final zeolite. Generally spoken, aqueous solutions with higher copper contents yield higher copper-containing zeolites. Which copper concentration should be chosen and how often the procedure shall be repeated can easily be determined by the skilled person without departing from the scope of the claims.

Optionally, the ammonium-exchanged zeolite can be subjected to heat treatment in order to decompose the ammonium ions. Subsequently, the copper exchange can be carried out as described above.

### Incipient Wetness Impregnation

An aqueous solution of a copper salt, for example copper acetate (Cu(Ac)₂), copper nitrate (Cu(NO₃)₂) or copper chloride (CuCl₂) is dissolved in an adequate volume of water. The amount of the copper salt is equal to the amount of copper preferred in the zeolite. The incipient wetness impregnation is carried out at room temperature. Afterwards, the copper-exchanged zeolite is dried at temperatures between 6° and 70° C. for 8 to 16 hours, and the mixture is subsequently heated to temperatures in the range of 550 to 900° C.

### Solid State Ion Exchange

Suitable copper salts are, for instance, copper acetate (Cu(Ac)₂), copper nitrate (Cu(NO₃)₂), copper chloride (CuCl₂), copper(II) oxide (CuO), copper(I) oxide (Cu₂O) and copper acetylacetonate (Cu(acac)₂). The copper salt and the zeolite are mixed in a dry state, and the mixture is subsequently heated to temperatures in the range of 550 to 900° C. A process for producing metal-comprising zeolites is, for instance, disclosed in US 2013/0251611 A1. This process may be applied to the zeolites of the present invention without departing from the scope of the claims.

The ion exchange methods which are exemplarily described above for exchanging copper and ammonium ions can be applied for the exchange of manganese as well. It is well known that the introduction of different metal ions, e.g. of copper and manganese ions, can be carried out sequentially or by co-ion exchange. A sequential ion exchange means that the different cations are introduced one after the other, for example by introducing copper in the first step and manganese in the second step. A co-ion exchange means that all cations, for example copper and manganese, are exchanged together in one step. Sequential and co-ion exchange can also be applied if more than two different cations shall be exchanged, for example cations of copper, manganese and a rare earth metal. The skilled person knows how to apply the ion exchange methods, which are exemplarily described above for the exchange of copper and ammonium ions, to the exchange of other ions, and he can apply this knowledge to the present invention without departing from the scope of the claims.

Suitable manganese salts for introducing manganese via ion exchange are, for example, manganese(II) acetate (Mn(CH₃COO)₂), manganese(II) acetylacetonate (Mn(acac)₂), manganese(II) acetylacetonate (Mn(acac)₃), manganese(II) chloride (MnCl₂), manganese(II) sulfate (MnSO₄) and manganese(II) nitrate (Mn(NO₃)₂).

The crystalline aluminosilicate zeolites having the CHA framework type according to the present invention can be used in a process for the removal of NOₓ from combustion exhaust gases. In this process, also known as SCR (selective catalytic reduction), these zeolites are used as the catalytically active compositions for the conversion of NOₓ. Therefore, the use of the zeolites according to the present invention as the catalytically active composition for the conversion of NOₓ is applicable exhaust purification systems of mobile and stationary combustion engines. Mobile combustion engines are, for example, gasoline and diesel engines and also hydrogen internal combustion engines (H₂ ICE). The skilled person knows that combustion processes usually take place under oxidizing conditions, and that either fuels comprises nitrogen or nitrogen compounds, which can be oxidized to NOₓ, and/or that the combustion takes place in the presence of air, wherein the oxygen which is present in the air acts as the oxidant, and at least a part of the nitrogen which is present in can be oxidized to NOₓ.

Mobile combustion engines can be engines for on-road and off-road applications, for example, gasoline and diesel engines and also hydrogen internal combustion engines for passenger cars, agricultural machinery like agricultural and forestry tractors and harvesting machines, construction wheel loaders, bulldozers, highway excavators, forklift trucks, road maintenance equipment, snow plows, ground support equipment in airports, aerial lifts and mobile cranes.

Stationary combustion engines are, for example, power stations, industrial heaters, cogeneration plants including wood-fired boilers, stationary diesel and gasoline engines, industrial and municipal waste incinerators, industrial drilling rigs, compressors, manufacturing plants for glass, steel and cement, manufacturing plants for nitrogen-containing fertilizers, nitric acid production plants (for example plants applying the Ostwald process) and ammonia burners for fueling gas turbines of nitric acid production.

In a preferred embodiment, the crystalline aluminosilicate small-pore zeolites according to the present invention can be used in a process for the removal of NOₓ from automotive combustion exhaust gases, said exhaust gases deriving from diesel or gasoline engines.

The object of providing devices for the treatment of exhaust gases of combustion engines is solved by catalysed substrate monoliths comprising an SCR catalytically active composition for the conversion of NOₓ for use in treating automotive combustion exhaust gases, wherein said SCR catalytically active composition for the conversion of NOₓ is a crystalline aluminosilicate zeolite having the CHA framework according to the present invention.

In some embodiments of the SCR catalytically active compositions according to the present invention, said SCR catalytically active composition is present in the form of a coating on a carrier substrate, i.e. as a washcoat on a carrier substrate. Carrier substrates can be so-called honeycomb flow-through substrates and wall-flow filters as well as corrugated substrates, wound or packed fiber filters, open cell foams and sintered metal filters. In a preferred embodiment, the carrier substrate is a honeycomb flow-through substrate or a honeycomb wall-flow filter.

Flow-through substrates and wall-flow filters may consist of inert materials, such as silicon carbide, aluminum titanate and cordierite. Such carrier substrates are well-known to the skilled person and available on the market. Corrugated substrates are made of ceramic E-glass fiber paper. They are also well known to the skilled person and available on the market.

When the SCR catalytically active composition is present in the form of a coating on a carrier substrate, it is typically present on or in the substrate in amounts from about 10 to about 600 g/L, preferably about 100 to about 300 g/L, as calculated by the weight of the molecular sieve per volume of the total catalyst article.

The SCR catalytically active composition can be coated on or into the substrate using known wash-coating techniques. In this approach the molecular sieve powder is suspended in a liquid medium together with binder(s) and stabilizer(s). The washcoat can then be applied onto the surfaces and walls of the substrate. The washcoat optionally also contains binders based on TiO₂, SiO₂, Al₂O₃, ZrO₂, CeO₂ and combinations thereof.

The washcoat may furthermore optionally comprise an additive. The additive may be present together with a binder, as mentioned above, or the washcoat may comprise only a binder or only an additive. Suitable additives are polysaccharides, polyvinylalcohols, glycerol; linear or branched-chain poly-functionalized organic molecules having two or more carbon atoms in the chain, with up to about 12 carbon atoms (Cₙ; wherein 2≤n≤12); salts of basic quaternary amines, wherein one or more quaternary amine groups are attached to four carbon chains having length of Cₙ, where 1≤n≤5 and wherein the cation is balanced as a salt using, but not limited to, one of the following anions: hydroxide, fluoride, chloride, bromide, iodide, carbonate, sulfate, sulfite, oxalate, maleate, phosphate, aluminate, silicate, borate, or other suitable organic or inorganic counter ions; inorganic bases taken from, but not limited to the following list: lithium hydroxide, sodium hydroxide, potassium hydroxide, magnesium hydroxide, calcium hydroxide, strontium hydroxide, and barium hydroxide; and, simple salts of transition or rare earth elements, including, but not limited to the following: nitrates, carbonates, sulfates, phosphates, borates of rare earth elements from atomic number 57 (La) to 71 (Lu) and including Sc, Y, Ti, Zr, and Hf, as mentioned above.

In a preferred embodiment, the additive is a polysaccharide selected from the group consisting of a galactomannan gum, xanthan gum, guar gum curdlan, Schizophyllan, Scleroglucan, Diutan gum, Welan gum, a starch, a cellulose or an alginate or is derived from a starch, a cellulose (i.e. cellulosic) or an alginate, and mixtures of thereof. Cellulosic additives may be selected from the group consisting of carboxymethyl cellulose, hydroxymethyl cellulose, hydroxyethyl cellulose, methyl cellulose, methyl hydroxyethyl cellulose, methyl hydroxypropyl cellulose and ethyl hydroxyethyl cellulose.

More preferably, the additive is xanthan gum, guar gum or a mixture thereof. Even more preferably the additive is xanthan gum.

In case the first and/or the second washcoat comprise an additive, said additive is present in an amount of up to 20 wt.-%, preferably 3 to 15 wt.-%, more preferably 6 to 10 wt.-%, based on the total weight of the oxides, wherein the “total weight of the oxides” is the sum of weights of the zeolite and the binder. It will be understood that, if the washcoat does not comprise a binder, the “total weight of the oxides” corresponds to the weight of the zeolite.

In other embodiments, the carrier substrates may be catalytically active on their own, and they may further comprise catalytically active compositions, i.e. a crystalline aluminosilicate zeolites according to the present invention. In addition to the catalytically active composition, these carrier substrates comprise a matrix component. All inert materials which are otherwise used for the manufacturing of catalyst substrates may be used as matrix components in this context. It deals, for instance, with silicates, oxides, nitrides or carbides, with magnesium aluminum silicates being particularly preferred.

In other embodiments of the SCR catalytically active compositions according to the present invention, the catalyst itself forms part of the carrier substrate, for example as part of a flow-through substrate or a wall-flow filter. Such carrier substrates additionally comprise the matrix components described above.

Carrier substrates comprising the SCR catalytically active compositions according to the present invention may be used as such in exhaust purification. Alternatively, they may be coated with catalytically active compositions, for example with SCR-catalytically active compositions. Insofar as these materials shall exhibit an SCR catalytic activity, the SCR catalytically active compositions mentioned above are suitable materials.

In one embodiment, catalytically active carrier materials are manufactured by mixing 10 to 95 wt.-% of at least one inert matrix component and 5 to 90 wt.-% of a catalytically active composition, followed by extruding the mixture according to well-known protocols. As already described above, inert materials that are usually used for the manufacture of catalyst substrates may be used as the matrix components in this embodiment. Suitable inert matrix materials are, for example, silicates, oxides, nitrides and carbides, with magnesium aluminum silicates being particularly preferred. Catalytically active carrier materials obtainable by such processes are known as “extruded catalysed substrate monoliths”.

The application of the catalytically active components onto either the inert carrier substrate or onto a carrier substrate which is catalytically active on its own as well as the application of a catalytically active coating onto a carrier substrate, said carrier substrate comprising a catalyst according to the present invention, can be carried out following manufacturing processes well known to the person skilled in the art, for instance by widely used dip coating, pump coating and suction coating, followed by subsequent thermal post-treatment (calcination).

The skilled person knows that in the case of wall-flow filters, their average pore sizes and the mean particle size of the catalytically active components according to the present invention may be adjusted to one another in a manner that the coating thus obtained is located onto the porous walls which form the channels of the wall-flow filter (on-wall coating). However, the average pore sizes and the mean particle sizes are preferably adjusted to one another in a manner that the catalyst according to the present invention is located within the porous walls which form the channels of the wall-flow filter. In this preferable embodiment, the inner surfaces of the pores are coated (in-wall coating). In this case, the mean particle size of the catalysts according to the present invention has to be sufficiently small to be able to penetrate the pores of the wall-flow filter. Wall-flow filters which are coated with an SCR catalytically active compositions are also known as “SDPF” (SCR on DPF, i.e. an SCR catalytically active composition coated onto a diesel particulate filter) or as “SCRF” (SCR on filter). Thus, the present invention encompasses catalysed substrate monoliths wherein the monolith is a wall-flow filter, and the SCR catalytically compositions comprises a crystalline aluminosilicate zeolite according to the present invention.

Furthermore, the present invention encompasses ammonia slip catalysts (ASC). It is well known to the skilled person that in exhaust gas purification systems, an ASC is preferably located downstream of the SCR, because recognizable amounts of NH₃ leave the SCR due to the dynamic driving conditions. Therefore, the conversion of excess ammonia which leaves the SCR is mandatory, since ammonia is also an emission regulated gas. Oxidation of ammonia leads to the formation of NO as main product, which would consequently contribute negatively to the total conversion of NOₓ of the whole exhaust system. An ASC may thus be located downstream the SCR to mitigate the emission of additional NO. The ASC catalyst combines the key NH₃ oxidation function with an SCR function. Ammonia entering the ASC is partially oxidized to NO. The freshly oxidized NO and NH₃ inside the ASC, not yet oxidized, can consequently react to N₂ following the usual SCR reaction schemes. In doing so, the ASC is capable of eliminating the traces of ammonia by converting them in a parallel mechanism to N₂.

It will be understood by the skilled person that the SCR catalyst and the ASC catalyst may be present as two consecutive catalytic articles, or the SCR functionality and the ASC functionality may be present on one single catalytic article. In case of two consecutive catalytic articles, the upstream catalytic article is the SCR catalyst comprising a carrier substrate and a washcoat comprising an SCR catalytically active composition, and the downstream catalytic article is the ASC catalyst comprising a carrier substrate, a washcoat comprising an oxidation catalyst, and a washcoat comprising an SCR catalytically active composition. In case the SCR catalyst and the ASC catalyst are present on one single substrate, a washcoat comprising an SCR catalytically active composition, but no oxidation catalyst is coated onto the upstream zone of the carrier substrate, and the downstream zone of said carrier substrate contains a bottom layer with a washcoat comprising an oxidation catalyst and a top layer with a washcoat comprising an SCR catalytically active composition. In all the embodiments wherein an SCR catalyst is combined with a downstream ASC catalyst, the SCR catalytically active composition of the SCR catalyst is preferably a crystalline aluminosilicate zeolite according to the present invention. The SCR catalytically active composition of the ASC can be selected from crystalline aluminosilicate zeolites according to the present invention, other zeolitic and non-zeolitic molecular sieves as described above, and mixed oxides comprising vanadia and titania. In case other zeolitic and non-zeolitic molecular sieves are used, they are preferably loaded with a least one transition metal, preferably copper and/or iron. In case a mixed oxide comprising vanadia and titania is used, it may optionally also comprise oxides of one or more elements selected from tungsten, silicon, aluminum, zirconium, molybdenum, niobium and antimony.

Platinum group metals are used as oxidation catalysts in an ASC, and zeolites may be used for the SCR function. The precious metal is a platinum group metal selected from ruthenium, rhodium, palladium, osmium, iridium, platinum and mixtures thereof. Preferably, the precious metal is chosen from palladium, platinum, rhodium and mixtures thereof, more preferably, the precious metal is platinum. In a preferred embodiment, the platinum group metal is added in the form of a precursor salt to a washcoat slurry and applied to the carrier monolith. The platinum group metal is present in a concentration of 0.01 to 10 wt.-%, preferably 0.05 to 5 wt.-%, even more preferably 0.1 to 3 wt.-%, calculated as the respective platinum group metal and based on the total weight of the washcoat loading. In a preferred embodiment, the platinum group metal is platinum, and it is present in a concentration of 0.1 to 1 wt.-%, calculated as Pt and based on the total weight of washcoat loading.

In one embodiment, the ASC catalyst is a catalysed substrate monolith, wherein the monolith is a flow-through monolith coated with a bottom layer comprising an oxidation catalyst and a top layer comprising a crystalline aluminosilicate zeolite having the CHA framework type according to the present invention.

In all devices for the treatment of exhaust gases of combustion engines comprising a crystalline aluminosilicate zeolite according to the present invention as the SCR catalytically active composition, it is possible to use one or more of these SCR catalytically active compositions. If more than one of the SCR catalytically active compositions are present, they can be present in the form of two or more different layers, two or more different zones, as a mixture of two or more different SCR catalytically active compositions within one washcoat. Furthermore, the layers or zone may, independently from one another, comprises one single SCR catalytically active composition or a mixture of two or more of SCR catalytically active compositions. Two or more crystalline aluminosilicate zeolites according to the present invention are “different” if they differ in at least one parameter selected from the framework type, the SAR value, the copper content and/or the manganese content.

The present invention furthermore provides an emissions treatment system for the removal of NOx emissions from exhaust gases of internal combustion engines, and optionally also for the removal of particulate matter, the system comprising, in the following order, from upstream to downstream:
a) means for injecting ammonia or an ammonia precursor solution into the exhaust gas stream,
b) a catalysed substrate monolith comprising an SCR-catalytically active composition for the conversion of NOx in automotive combustion exhaust gases, wherein
   said SCR catalytically active compositions for the conversion of NOx is a crystalline aluminosilicate zeolite having the CHA framework type according to the present invention, and wherein the substrate monolith is selected from honeycomb flow-through substrates, honeycomb wall-flow filters, corrugated substrates, wound or packed fiber filters, open cell foams, sintered metal filters and extruded catalysed substrate monoliths.

It will be understood by the skilled person that in case the substrate monolith is a flow-through monolith or a corrugated substrate, the corresponding catalysed substrate monolith will remove NOx emissions only. If, however, the substrate monolith is a wall-flow filter, the corresponding catalysed substrate monolith will also remove particulate matter.

The skilled person knows that the SCR reaction requires the presence of ammonia as a reductant. Ammonia may be supplied in an appropriate form, for instance in the form of liquid ammonia or in the form of an aqueous solution of an ammonia precursor, and added to the exhaust gas stream as needed via means for injecting ammonia or an ammonia precursor. Suitable ammonia precursors are, for instance urea, ammonium carbamate or ammonium formate. Alternatively, the ammonia may be formed by catalytic reactions within the exhaust gas.

A widespread method is to carry along an aqueous urea solution and to and to dose it into the catalyst according to the present invention via an upstream injector and a dosing unit as required. Means for injecting ammonia, for example an upstream injector and a dosing unit, are well known to the skilled person and can be used in the present invention without departing from the scope of the claims.

It will furthermore be understood that an emissions treatment system for the removal of NOₓ emissions from exhaust gases of internal combustion engines, and optionally also for the removal of particulate matter, the system comprising a catalysed substrate monolith comprising an SCR-catalytically active composition for the conversion of NOₓ in automotive combustion exhaust gases, wherein said SCR catalytically active compositions for the conversion of NOₓ is a crystalline aluminosilicate zeolite according to the present invention, may comprise additional catalytic articles, for instance a diesel oxidation catalyst (DOC), an ammonia slip catalyst (ASC), a catalysed or uncatalysed particulate filter, a passive NOₓ adsorber (PNA), and/or a lean NOₓ trap (LNT). A catalysed particulate filter may be coated with a diesel oxidation catalyst, thus forming a “catalysed diesel particulate filter (CDPF), or it may be coated with an SCR catalytically active composition, thus forming an SDPF.

In one embodiment of the present invention, the emissions treatment system comprising a catalysed substrate monolith comprising an SCR-catalytically active composition according to the present invention is arranged in a close-coupled position. The term “close-coupled” refers to a position of a catalytic device in an engine's exhaust gas treatment system which is less than 1 meter downstream of the engine's exhaust gas manifold or turbocharger. In a preferred embodiment, the emissions treatment system comprising a catalysed substrate monolith comprising an SCR-catalytically active composition according to the present invention furthermore comprises one or more particulate filters. In this embodiment, the “first” filter is the filter that is arranged closest to the engine. The “second” filter, if present, is located downstream of the first filter, either directly following the first filter, or in a position further downstream. In this embodiment, the catalysed substrate monolith comprising an SCR-catalytically active composition according to the present invention, which is arranged in a close-coupled position, is arranged upstream of the first filter.

As mentioned above, the substrate monolith can be a honeycomb flow-through substrate, a honeycomb wall-flow filter, a corrugated substrate, a wound or packed fiber filter, an open cell foam or a sintered metal filter. Preferably, it is a honeycomb flow-through substrate or a honeycomb wall-flow filter. If the catalysed substrate monolith is a honeycomb wall-flow filter comprising an SCR-catalytically active composition according to the present invention, it deals with an SDPF.

In yet another embodiment of the present invention, the emissions treatment system is arranged in an underfloor position. Underfloor catalyst members are also known in the prior art and are located downstream of any close-coupled and/or medium-coupled catalysts under the floor of the vehicle adjacent to or in combination with the vehicle's muffler. In this embodiment, the catalysed substrate monolith comprising an SCR-catalytically active composition according to the present invention is arranged downstream the first filter. The substrate monoliths comprising an SCR-catalytically active composition according to the present invention are the same as those mentioned above for the close-coupled arrangement.

In yet another embodiment of the present invention, the emissions treatment system comprising a catalysed substrate monolith comprising an SCR-catalytically active composition according to the present invention is arranged upstream of the first particulate filter, but 1 meter or more downstream of the engine's exhaust gas manifold or turbocharger. In this embodiment, the catalysed substrate monolith comprising an SCR-catalytically active composition according to the present invention preferably is the first brick downstream of the engine's exhaust gas manifold or turbocharger.

In yet another embodiment of the present invention, the emissions treatment system comprising a catalysed substrate monolith comprising an SCR-catalytically active composition according to the present invention is arranged downstream of the first particulate filter.

In these embodiments wherein the catalysed substrate monolith comprising an SCR-catalytically active composition according to the present invention is located either upstream or downstream of the first particulate filter, the substrate monoliths comprising an SCR-catalytically active composition according to the present invention are the same as those mentioned above for the close-coupled arrangement and the underfloor arrangement.

The present invention furthermore provides a method for the removal of NOx emissions from exhaust gases of internal combustion engines, and optionally also for the removal of particulate matter, the method comprising, in the following order, from upstream to downstream:
a) injecting ammonia or an ammonia precursor solution into the exhaust gas stream,
b) introducing the exhaust gas from step a) into a catalysed substrate monolith comprising an SCR-catalytically active composition for the conversion of NOx in automotive combustion exhaust gases, wherein said SCR catalytically active compositions for the conversion of NOx is a crystalline aluminosilicate zeolite having the CHA framework type according to the present invention, and wherein the substrate monolith is selected from honeycomb flow-through substrates, honeycomb wall-flow filters, corrugated substrates, wound or packed fiber filters, open cell foams, sintered metal filters and extruded catalysed substrate monoliths.

As mentioned above for the emissions treatment system, it will be understood by the skilled person that in case the substrate monolith used in step b) of the method above is a flow-through monolith or a corrugated substrate, the corresponding catalysed substrate monolith will remove NOx emissions only. If, however, the substrate monolith used in step b) of the method above is a wall-flow filter, the corresponding catalysed substrate monolith will also remove particulate matter.

### BRIEF DESCRIPTION OF THE DRAWINGS

FIG. 1 shows the NOₓ conversion in percent in the standard SCR reaction (“NO only”) in the fresh state for Comparative Example 1 and Examples 1, 2, 3 and 4.

FIG. 2 shows the N₂O concentration in ppm in the standard SCR reaction (“NO only”) in the fresh state for Comparative Example 1 and Examples 1, 2, 3 and 4.

FIG. 3 shows the N₂O selectivity in percent in the standard SCR reaction (“NO only”) and with 25% and 50% NO₂ in the fresh state for Comparative Example 1 and Examples 1, 2, 3 and 4.

FIG. 4 shows the N₂O selectivity in percent in the standard SCR reaction (“NO only”) and with 25% and 50% NO₂ in the aged state for Comparative Example 1 and Examples 1, 2, 3 and 4. Aging was performed at 750° C. for 16 h.

FIG. 5 shows the NOₓ conversion in percent in the standard SCR reaction (“NO only”) in the aged state for Comparative Example 1 and Examples 1, 2, 3 and 4. Aging was performed at 750° C. for 16 h.

FIG. 6 shows the N₂O concentration in ppm in the standard SCR reaction (“NO only”) in the aged state for Comparative Example 1 and Examples 1, 2, 3 and 4. Aging was performed at 750° C. for 16 h.

FIG. 7 shows the NOₓ conversion in percent in the SCR reaction in NO-only at 180° C. in the fresh state for Comparative Example 2 and Examples 5, 6, 7, 8 and 9.

FIG. 8 shows the N₂O concentration in ppm in the SCR reaction in NO-only at 250° C. in the fresh state for Comparative Example 2 and Examples 5, 6, 7, 8 and 9.

FIG. 9 shows the delta NOₓ, i.e. the difference of the NOₓ conversion in percent in the SCR reaction with 50% NO₂ at 180° C. of Examples 5 to 9 minus the corresponding NOₓ conversion of Comparative Example 2 in the fresh state.

FIG. 10 shows the delta N₂O, i.e. the difference in the N₂O formation in ppm in the SCR reaction with 50% NO₂ at 250° C. of Comparative Example 2 minus the corresponding N2O formation of Examples 5 to 9 in the fresh state.

FIG. 11 shows the NOₓ conversion in percent in the SCR reaction in NO-only at 180° C. in the aged state for Comparative Example 2 and Examples 5, 6, 7, 8 and 9. Aging was performed at 750° C. for 16 h.

FIG. 12 shows the N₂O concentration in ppm in the SCR reaction in NO-only at 250° C. in the aged state for Comparative Example 2 and Examples 5, 6, 7, 8 and 9. Aging was performed at 750° C. for 16 h.

FIG. 13 shows the delta NOₓ, i.e. the difference of the NOₓ conversion in percent in the SCR reaction with 50% NO₂ at 180° C. of Examples 5 to 9 minus the corresponding NOₓ conversion of Comparative Example 2 in the aged state. Aging was performed at 750° C. for 16 h.

FIG. 14 shows the delta N₂O, i.e. the difference in the N₂O formation in ppm in the SCR reaction with 50% NO₂ at 250° C. of Comparative Example 2 minus the corresponding N2O formation of Examples 5 to 9 in the aged state. Aging was performed at 750° C. for 16 h.

### EMBODIMENTS

### Preparation of Powders for Comparative Example 1, Comparative Example 2 and Examples 1-9:

A purchased zeolite powder of the CHA framework structure, in H⁺-form, and with an SAR of 13 was used as base zeolite material. 1.2 kg of the base zeolite was impregnated with an aqueous solution of Cu(NO₃)₂, which was dosed over 30 min while constantly mixing the powder in a closed stainless steel container. The aqueous Cu(NO₃)₂ solution was prepared from a mixture of 540 g de-ionised water and 122.1 g Cu(NO₃)₂*3H₂O, where the Cu-salt was fully dissolved before addition to the zeolite powder. After impregnation, the Cu-loaded zeolite was dried for 8 h at 120° C. and calcined at 600° C. for 2 h.

For the preparation of powders for Examples 1-4, an aqueous solution containing 122.1 g Cu(NO₃)₂*3H₂O and X g of a Mn(NO₃)₂ solution containing 15 wt % Mn, was mixed with de-ionised water to a total water amount of 540 g. For Example 1-4, the value of X is 46.2 g, 92.3 g, 138.5 g and 184.7 g, respectively.

The preparation of the powders for Comparative Example 2 (CE2) and for Examples 5 to 9 (Ex5 to Ex9) was carried out analogously to that for Examples 1 to 4. The compositions are listed in Table 1. Comparative Example 2 corresponds to Example 1g of US 2015/078989 A1.

### Preparation of Coated Catalysts for Comparative Example 1 and Example 1-4:

The powders prepared for Comparative Example 1 and Examples 1-4, were each coated onto their individual commercial extruded monolith carrier material of the dimensions 5.66″ diameter and 3.0″ length, and with channel dimensions 400 cpsi and wall thickness of 4 mil. A slurry consisting of H₂O, Al₂O₃ as binder, and the prepared Cu/Mn-zeolite powder was mixed and left for stirring overnight. The commercial monolith carrier was submerged into the slurry, and subsequently dried by a flow of hot air. The process was repeated until reaching a loading of the dry coating of 150 g/L.

TABLE 1
Compositions of Comparative Example 1 and Examples 1 to 4

| | | CuO | MnO | Cu:Al | (Cu + Mn):Al |
|---|---|---|---|---|---|
| Example | SAR | (wt.%) | (wt.%) | atomic ratio | atomic ratio |
| Comparative | 13 | 3.5 | 0 | 0.16 | |
| Example 1 | | | | | |
| Example 1 | 13 | 3.5 | 0.78 | 0.16 | 0.25 |
| Example 2 | 13 | 3.5 | 1.56 | 0.16 | 0.3 |
| Example 3 | 13 | 3.5 | 2.34 | 0.16 | 0.35 |
| Example 4 | 13 | 3.5 | 3.12 | 0.17 | 0.4 |
| CE 2 | 17 | 3.0 | 0.8 | 0.18 | 0.28 |
| Ex5 | 17 | 3.0 | 1.2 | 0.18 | 0.31 |
| Ex6 | 17 | 3.0 | 1.5 | 0.18 | 0.34 |
| Ex7 | 13 | 3.0 | 2.2 | 0.14 | 0.31 |
| Ex8 | 13 | 3.0 | 2.6 | 0.14 | 0.34 |
| Ex9 | 13 | 3.8 | 1.9 | 0.18 | 0.34 |

Aging, Measurement of NOₓ Conversion and N₂O Formation of Comparative Example 1 and Examples 1 to 4

The coated catalysts were measured after preparation and after aging in a hydrothermal atmosphere (10% H₂O, 10% O₂, remainder N₂). The holding times and aging temperatures were 16 h at 750° C. in hydrothermal atmosphere.

The NOx conversion of the catalysts as a function of the temperature upstream of the catalyst was determined in a model gas reactor in the so-called NOx conversion test.

This NOx conversion test consists of a test procedure that comprises a pre-treatment and a test cycle that is run through for various target temperatures.

### Test Procedure:

1. Preconditioning at 600° C. in N₂ for 10 min
2. Test cycle repeated for the target temperatures
   a. Approaching the target temperature in gas mixture 1
   b. Addition of NOₓ (gas mixture 2)
   c. Addition of NH₃ (gas mixture 3), wait until NH₃ breakthrough >20 ppm, or a maximum of 30 min. in duration
   d. Temperature-programmed desorption up to 500° C. (gas mixture 3)

In case of NO-only measurements (Table 2a), measurements with 25% NO₂ of the NOx concentration (Table 2b) and with 50% NO₂ of the NOₓ concentration (Table 2c) the NOx concentration in the gas compositions in test procedure range 3 and 4 are adjusted accordingly.

TABLE 2a
Gas mixtures of the NOₓ conversion test under NO-only conditions

| | | | |
|---|---|---|---|
| Gas mixtur | 1 | 2 | 3 |

| | | | |
|---|---|---|---|
| N₂ | Balance | Balance | Balance |

| | | | | | | |
|---|---|---|---|---|---|---|
| O₂ | 10 | vol % | 10 | vol % | 10 | vol % |
| NOx | 0 | ppm | 500 | ppm | 500 | ppm |
| NO₂ | 0 | ppm | 0 | ppm | 0 | ppm |
| NH₃ | 0 | ppm | 0 | ppm | 750 | ppm |
| H₂O | 5 | vol % | 5 | vol % | 5 | vol % |

TABLE 2b
Gas mixtures of the NOₓ conversion test
with 25% NO₂ of the NOₓ concentration

| | | | |
|---|---|---|---|
| Gas mixture | 1 | 2 | 3 |

| | | | |
|---|---|---|---|
| N₂ | Balance | Balance | Balance |

| | | | | | | |
|---|---|---|---|---|---|---|
| O₂ | 10 | vol % | 10 | vol % | 10 | vol % |
| NOx | 0 | ppm | 375 | ppm | 375 | ppm |
| NO₂ | 0 | ppm | 125 | ppm | 125 | ppm |
| NH₃ | 0 | ppm | 0 | ppm | 750 | ppm |
| H₂O | 5 | vol % | 5 | vol % | 5 | vol % |

TABLE 2c
Gas mixtures of the NOₓ conversion test
with 50% NO₂ of the NOₓ concentration

| | | | |
|---|---|---|---|
| Gas mixture | 1 | 2 | 3 |

| | | | |
|---|---|---|---|
| N₂ | Balance | Balance | Balance |

| | | | | | | |
|---|---|---|---|---|---|---|
| O₂ | 10 | vol % | 10 | vol % | 10 | vol % |
| NOx | 0 | ppm | 250 | ppm | 250 | ppm |
| NO₂ | 0 | ppm | 250 | ppm | 250 | ppm |
| NH₃ | 0 | ppm | 0 | ppm | 750 | ppm |
| H₂O | 5 | vol % | 5 | vol % | 5 | vol % |

The gas hourly space velocity (GHSV) for the measurements of the catalysts was at 60,000 h⁻¹ at all measurement temperatures.

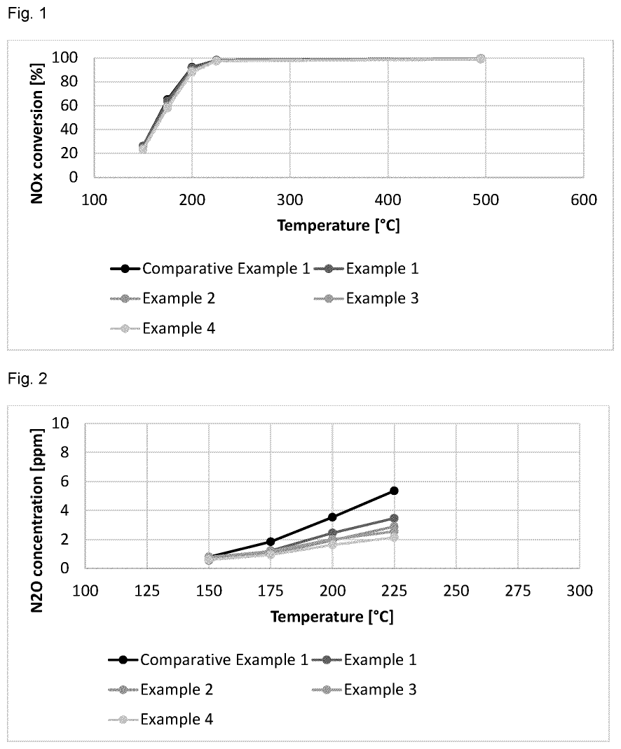

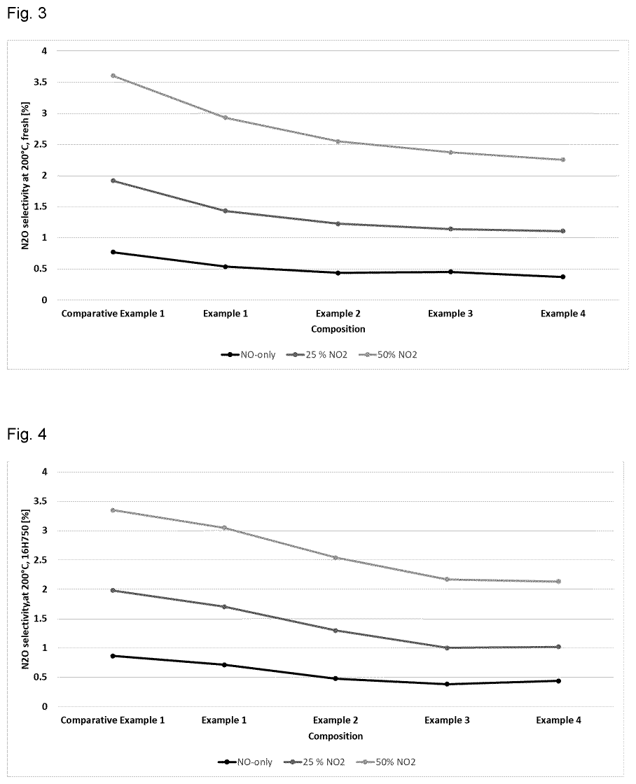

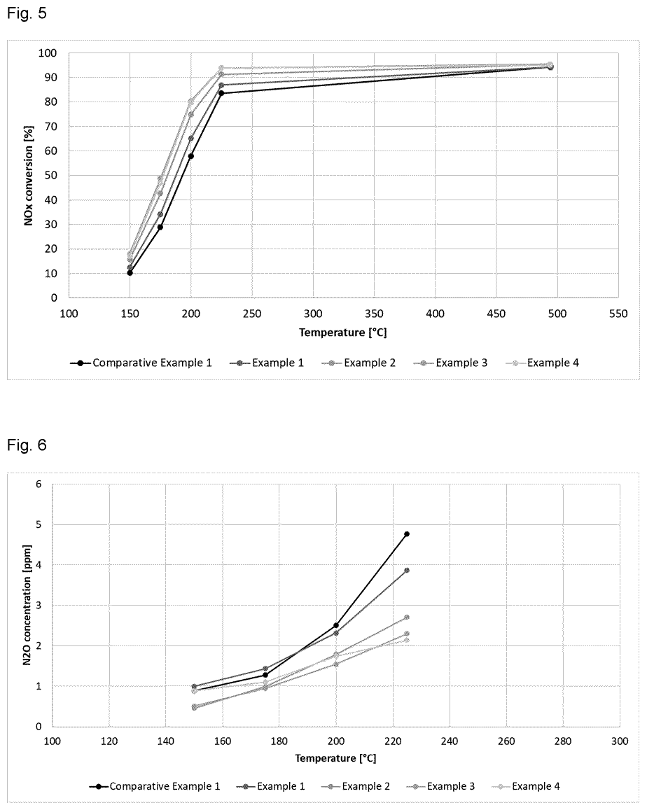

For each temperature point below 500° C., the conversion with an NH₃ slip of 20 ppm is determined for test procedure range 2c. For temperature point at 500° C., the conversion in a state of equilibrium is determined in the test procedure range 2c. Plotting this NOx conversion for the various temperature points results in a plot as shown in FIGS. 1 and 3.

The following tables show the NOₓ conversion rates in percent, the N₂O concentration in ppm and the N₂O selectivity in percent for the NOₓ conversion test conditions given in Tables 2a to 2c.
CE1=Comparative Example 1, Ex1 to Ex4=Examples 1 to 4

TABLE 3
NOₓ conversion in percent and N₂O concentration in ppm
in the SCR reaction with 25% NO₂ in the fresh state
for Comparative Example 1 and Examples 1, 2, 3 and 4

| T | X(NOₓ) [%] | | | | | c(N₂O) [ppm] | | | | |
|---|---|---|---|---|---|---|---|---|---|---|
| [° C.] | CE1 | Ex1 | Ex2 | Ex3 | Ex4 | CE1 | Ex1 | Ex2 | Ex3 | Ex4 |
| 200 | 94.21 | 94.14 | 92.56 | 92.15 | 91.97 | 5.41 | 4.21 | 3.66 | 3.17 | 3.37 |
| 225 | 98.29 | 98.83 | 97.91 | 97.65 | 98.16 | 7.86 | 5.86 | 4.71 | 3.81 | 3.90 |
| 250 | 99.12 | 99.45 | 98.81 | 98.82 | 99.34 | 9.95 | 7.05 | 5.49 | 4.26 | 4.29 |

TABLE 4
NOₓ conversion in percent and N₂O concentration in ppm
in the SCR reaction with 50% NO₂ in the fresh state
for Comparative Example 1 and Examples 1, 2, 3 and 4

| T | X(NOₓ) [%] | | | | | c(N₂O) [ppm] | | | | |
|---|---|---|---|---|---|---|---|---|---|---|
| [° C.] | CE1 | Ex1 | Ex2 | Ex3 | Ex4 | CE1 | Ex1 | Ex2 | Ex3 | Ex4 |
| 200 | 95.16 | 95.30 | 94.53 | 94.97 | 94.31 | 8.02 | 7.14 | 6.24 | 5.86 | 5.42 |
| 225 | 98.80 | 98.94 | 98.53 | 99.09 | 98.43 | 11.91 | 9.95 | 8.37 | 7.50 | 6.71 |
| 250 | 99.31 | 99.55 | 99.29 | 99.78 | 99.18 | 15.87 | 12.28 | 9.72 | 8.28 | 7.14 |

TABLE 5
NOₓ conversion in percent and N₂O concentration in ppm in the SCR reaction
with 25% NO₂ in the aged state for Comparative Example 1 and Examples
1, 2, 3 and 4. Aging was performed at 750° C. for 16 h.

| T | X(NOₓ) [%] | | | | | c(N₂O) [ppm] | | | | |
|---|---|---|---|---|---|---|---|---|---|---|
| [° C.] | CE1 | Ex1 | Ex2 | Ex3 | Ex4 | CE1 | Ex1 | Ex2 | Ex3 | Ex4 |
| 200 | 75.68 | 79.29 | 84.46 | 87.20 | 87.04 | 4.22 | 3.92 | 3.47 | 2.69 | 2.54 |
| 225 | 90.40 | 92.43 | 94.41 | 95.35 | 95.93 | 6.71 | 5.54 | 4.53 | 3.41 | 3.04 |
| 250 | 96.15 | 97.34 | 97.72 | 97.58 | 98.27 | 10.13 | 8.01 | 6.29 | 4.67 | 3.85 |

TABLE 6
NOₓ conversion in percent and N₂O concentration in ppm in the SCR reaction
with 50% NO₂ in the aged state for Comparative Example 1 and Examples
1, 2, 3 and 4. Aging was performed at 750° C. for 16 h.

| T | X(NOₓ) [%] | | | | | c(N₂O) [ppm] | | | | |
|---|---|---|---|---|---|---|---|---|---|---|
| [° C.] | CE1 | Ex1 | Ex2 | Ex3 | Ex4 | CE1 | Ex1 | Ex2 | Ex3 | Ex4 |
| 200 | 91.86 | 91.41 | 93.74 | 92.58 | 94.26 | 6.29 | 6.17 | 5.47 | 5.75 | 5.23 |
| 225 | 97.61 | 97.64 | 98.08 | 97.77 | 98.42 | 9.97 | 9.17 | 6.92 | 7.93 | 6.18 |
| 250 | 98.97 | 98.49 | 98.86 | 99.15 | 99.24 | 14.56 | 12.74 | 8.63 | 10.64 | 7.43 |

The data from Tables 3 to 6 show that in the fresh state, the CHA aluminosilicate zeolites according to the present invention show a disproportional decrease of the NOₓ conversion and the N₂O formation. This means that in the fresh state, the N₂O formation of the CHA zeolites according to the present invention decreases more than the corresponding NOₓ conversion, when compared with the Comparative Example. In the aged state, the CHA zeolites according to the present invention show an increased NOₓ conversion with a concomitant decrease in N₂O formation.

### Aging, Measurement of NOx Conversion and N₂O Formation of Comparative Example 2 and Examples 5 to 9

The NOₓ conversion of Comparative Example 2 and Examples 5 to 9 were measured at 180° C. in the fresh and aged state of the catalyst powders.

The N₂O formation was measured at 250° C. in the fresh and the aged state of the catalyst powders.

The measurements were performed using a conventional plug flow model. In these measurements gas streams, simulating lean burn exhaust gas from the engine, were passed over and through meshed particles of test samples under conditions of varying temperature and the effectiveness of the sample in NOx reduction was determined by means of on-line FTIR (Fourier Transform Infra-Red) spectrometer.

Table 7 below details the full experimental parameters employed in the generation of the data included herein.

TABLE 7
Model Gas testing conditions

| Component/Parameter | Concentration/Setting (NO only) | |
|---|---|---|
| NH₃ | 750 | ppm |
| NO | 500 | ppm |
| H₂O | 4% | |
| O₂ | 5% | |
| Temperature | Ramp 600 to 100° C. @ −2° C./min | |
| Sample mass | 180 | mg |
| Particle size of sample | 300-500 | μm |
| GHSV | 250,000 | h⁻¹ |

The results are listed in Tables 8 and 9

“delta NOₓ” was calculated by subtracting the value of the NOₓ conversion of CE2 from the corresponding value of the NOₓ conversion of Ex5 to Ex9.

“delta N₂O” was calculated by subtracting the value of the N₂O formation of Ex5 to Ex9 from the corresponding value of the N₂O formation of CE2.

Positive delta values indicate that the respective Example Ex5 to Ex9 shows a better NOₓ conversion or a lower N₂O formation than CE2. Negative delta values indicate CE2 shows a better NOₓ conversion or a lower N₂O formation than Ex5 to Ex9., respectively.

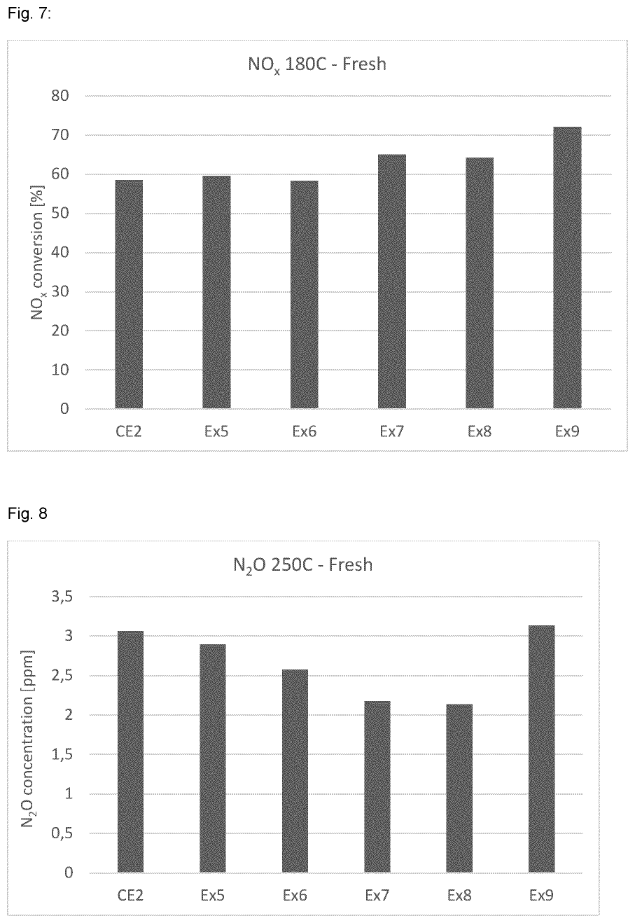

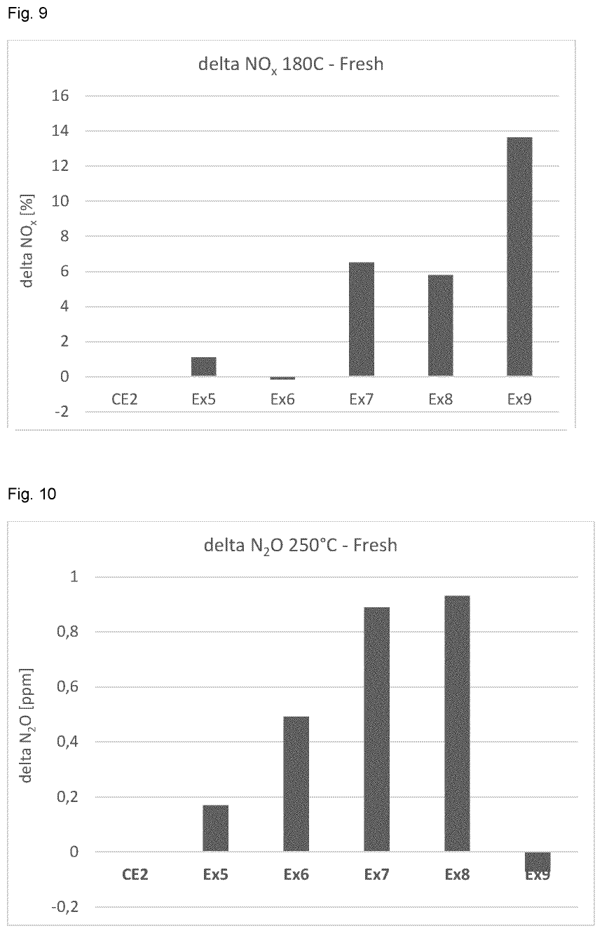

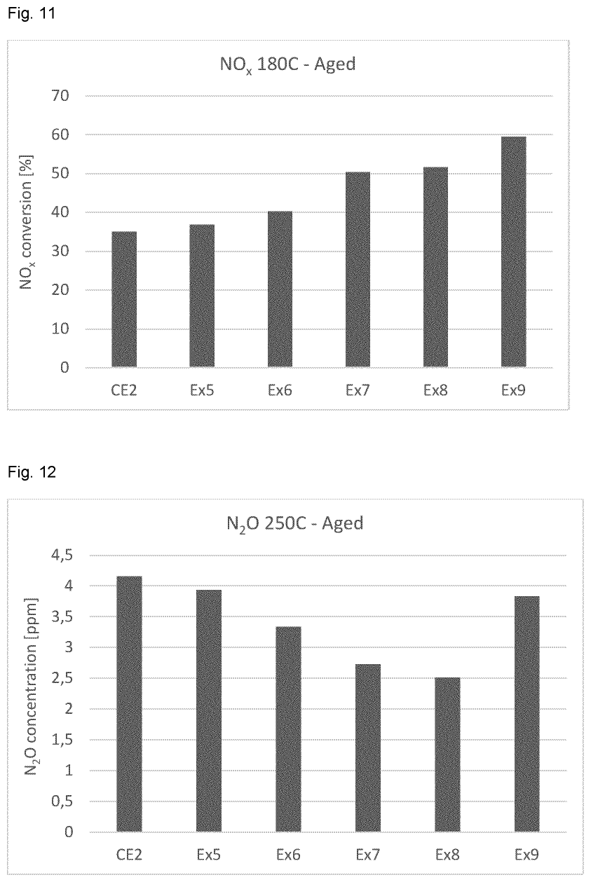

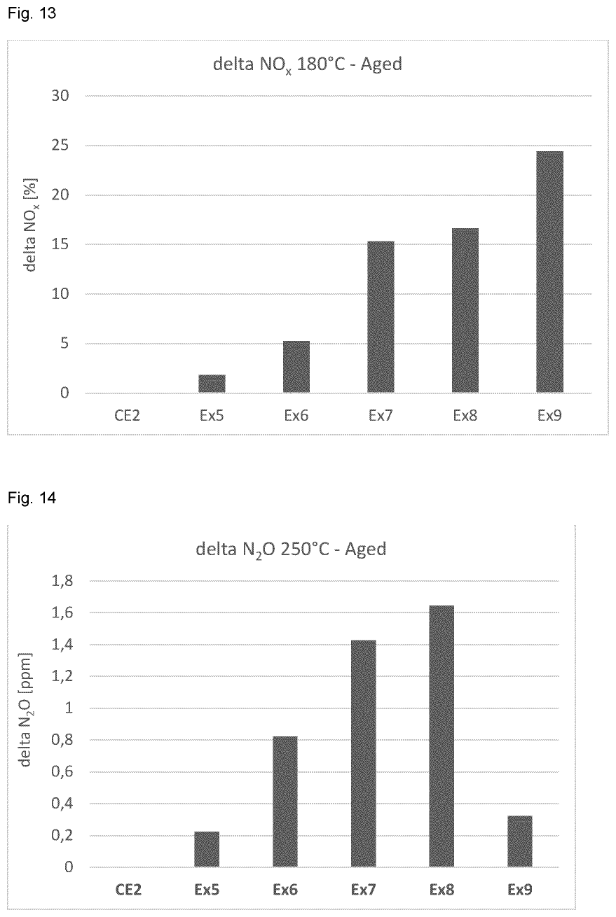

The results are shown in FIGS. 7 to 14.

TABLE 8
NOₓ conversion in percent at 180° C. and
the N₂O concentration in ppm at 250° C. in the SCR
reaction with 50% NO₂ in the fresh state for Comparative
Example 2 and Examples 5 to 9, abbreviated as CE2 and Ex5 to Ex9,
and also the differences of CE2 to Ex5 to Ex9, indicated
as “delta NOₓ” and “delta N₂O”.

| | | | | delta(N₂O) |
|---|---|---|---|---|
| | X(NOₓ) [%]; | c(N₂O) [ppm] | delta(NOₓ) [%]; | [ppm] |
| Sample | T = 180° C. | T = 250° C. | T = 180° C. | T= 250° C. |
| CE2 | 58.45 | 3.06 | 0 | 0 |
| Ex5 | 59.55 | 2.89 | 1.10 | 0.17 |
| Ex6 | 58.28 | 2.57 | −0.16 | 0.49 |
| Ex7 | 64.96 | 2.17 | 6.51 | 0.89 |
| Ex8 | 64.22 | 2.13 | 5.78 | 0.93 |
| Ex9 | 72.08 | 3.13 | 13.64 | −0.07 |

TABLE 9
NOₓ conversion in percent at 180° C. and
the N₂O concentration in ppm at 250° C. in the SCR
reaction with 50% NO₂ in the aged state for Comparative
Example 2 and Examples 5 to 9, abbreviated as CE2 and Ex5 to Ex9,
and also the differences of CE2 to Ex5 to Ex9, indicated
as “delta NOₓ” and “delta N₂O”.

| | | | | delta(N₂O) |
|---|---|---|---|---|
| | X(NOₓ) [%]; | c(N₂O) [ppm] | delta(NOₓ) [%]; | [ppm] |
| Sample | T = 180° C. | T = 250° C. | T = 180° C. | T = 250° C. |
| CE2 | 35.03 | 4.15 | 0 | 0 |
| Ex5 | 36.84 | 3.93 | 1.82 | 0.22 |
| Ex6 | 40.26 | 3.33 | 5.23 | 0.82 |
| Ex7 | 50.32 | 2.73 | 15.29 | 1.43 |
| Ex8 | 51.65 | 2.51 | 16.62 | 1.64 |
| Ex9 | 59.42 | 3.83 | 24.39 | 0.32 |

1. A catalytically active composition comprising a crystalline aluminosilicate zeolite having the CHA framework type, wherein the zeolite has a SAR value of between 7 and 25, a copper content of between 3.0 and 4.5 wt.-%, a manganese content of 0.3 to 4.0 wt. %, wherein copper and manganese are calculated as CuO and MnO and based on the total weight of the zeolite, and wherein the sum of the molar amounts of copper and manganese, divided by the molar amount of aluminum, is in the range of between 0.11 and 0.96.

2. The catalytically active composition according to claim 1, wherein the crystalline aluminosilicate having the CHA framework structure is selected form the zeotypes SSZ-13, LZ-218, Linde D, Linde R, Phi and ZK-14.

3. The catalytically active composition according to claim 1, wherein the crystalline aluminosilicate having the CHA framework structure has a SAR value of between 10 and 23.

4. The catalytically active composition according to claim 1, wherein the crystalline aluminosilicate having the CHA framework structure has a copper content of between 3.3 and 3.7 wt.-%, calculated as CuO and based on the total weight of the zeolite.

5. The catalytically active composition according to claim 1, wherein the crystalline aluminosilicate having the CHA framework structure has a manganese content of between 0.6 and 4.0 wt.-%, calculated as MnO and based on the total weight of the zeolite.

6. The catalytically active composition according to claim 1, wherein the sum of the molar amounts of copper and manganese, divided by the amount of aluminum, is in the range of between 0.25 to 0.40.

7. A process for the removal of NOx from combustion exhaust gases, wherein a crystalline aluminosilicate zeolite having the CHA framework type according to claim 1 is used as the SCR catalytically active composition for the conversion of NOx.

8. The catalysed substrate monolith comprising an SCR catalytically active composition for the conversion of NOx for use in treating automotive combustion exhaust gases, wherein said SCR catalytically active composition for the conversion of NOx is a crystalline aluminosilicate zeolite according to claim 1.

9. The catalysed substrate monolith according to claim 8, wherein the crystalline aluminosilicate zeolite is present in the form of a washcoat on a carrier substrate.

10. The catalysed substrate monolith according to claim 8, wherein the carrier substrate is a flow-through substrate, a wall-flow filter, or a corrugated substrate.

11. The catalysed substrate monolith according to claim 8, wherein the catalysed substrate monolith is an extruded catalysed substrate monolith.

12. The catalysed substrate monolith according to claim 9, wherein the monolith is a flow-through monolith coated with a bottom layer comprising an oxidation catalyst and a top layer comprising the crystalline aluminosilicate zeolite having the CHA framework type.

13. An emissions treatment system for the removal of NOx emissions from exhaust gases of internal combustion engines, and optionally also for the removal of particulate matter, the system comprising, in the following order, from upstream to downstream:
a) means for injecting ammonia or an ammonia precursor solution into the exhaust gas stream,
b) a catalysed substrate monolith comprising an SCR-catalytically active composition for the conversion of NOx in automotive combustion exhaust gases, wherein said SCR catalytically active compositions for the conversion of NOx is a crystalline aluminosilicate zeolite having the CHA framework type according to claim 1, and wherein the substrate monolith is selected from honeycomb flow-through substrates, honeycomb wall-flow filters, corrugated substrates, wound or packed fiber filters, open cell foams, sintered metal filters, and extruded catalysed substrate monoliths.

14. The emissions treatment system according to claim 13, wherein said emissions treatment system is arranged in a close-coupled position.

15. The emissions treatment system according to claim 13, wherein said emissions treatment system is arranged in an underfloor position.

16. A method for the removal of NOx emissions from exhaust gases of internal combustion engines, and optionally also for the removal of particulate matter, the method comprising, in the following order, from upstream to downstream:
a) injecting ammonia or an ammonia precursor solution into the exhaust gas stream,
b) introducing the exhaust gas from step a) into a catalysed substrate monolith comprising an SCR-catalytically active composition for the conversion of NOx in automotive combustion exhaust gases, wherein said SCR catalytically active compositions for the conversion of NOx is a crystalline aluminosilicate zeolite having the CHA framework type according to claim 1, and wherein the substrate monolith is selected from honeycomb flow-through substrates, honeycomb wall-flow filters, corrugated substrates, wound or packed fiber filters, open cell foams, sintered metal filters, and extruded catalysed substrate monoliths.

17. The method according to claim 16, wherein the internal combustion engine is selected from gasoline, diesel, and hydrogen internal combustion engines (H₂ ICE).
